(19) United States
(12) Patent Application Publication
(10) Pub. No.: US 2025/0222422 A1
(43) Pub. Date: Jul. 10, 2025

(54) Modified gas treatment plant shutdown procedure with flaring minimization

(71) Applicant: SAUDI ARABIAN OIL COMPANY, Dhahran (SA)

(72) Inventors: Mohammed A. Alsallumi, Makkah (SA); Muntazer N. Alawi, Al Qatif (SA); Mohammed Alshobaian, Dhahran (SA)

(73) Assignee: SAUDI ARABIAN OIL COMPANY, Dhahran (SA)

(21) Appl. No.: 18/409,575

(22) Filed: Jan. 10, 2024

(51) Int. Cl. B01J 19/00

(52) U.S. Cl. CPC B01J 19/002; B01J 2219/00027; B01J 2219/00065; B01J 2219/00162; B01J 2219/00265; B01J 2219/00337

(57) ABSTRACT

A method for shutting down a gas treatment plant to minimize flaring and allow for continued production during the shutdown procedure. The method includes reducing a sour gas feed flow rate and monitoring pressures in headers for various process units to identify when pressure equalization occurs. The method includes sampling the rich solvent in the system to verify a setpoint concentration of hydrogen sulfide has been reached to initiate a final system shutdown.

### BACKGROUND

Amine gas treating is a process that is widely used in refineries, petrochemical plants, natural gas processing plants, and other applications. Amine gas treating, also known as amine scrubbing, gas sweetening, and acid gas removal, is a process that uses an aqueous amine solution to remove hydrogen sulfide (H₂S), carbon dioxide (CO₂), and other acid gases, from hydrocarbon gas streams. Gas streams containing one or more of the acid gases may be referred to as “sour gas” whether it is from a natural or a fabricated source. Natural gas with little to no hydrogen sulfide is known as “sweetened gas” or “sweet gas.”

Flares are safety devices that allow burning of excess gases that cannot be recovered or recycled. Rather than releasing the gases directly to the environment, the gases are combined with steam and air, and are burned in the flare system to be released as water vapor and carbon dioxide.

Carbon dioxide (CO₂) is a naturally occurring compound that is present in the atmosphere. The CO₂ in the atmosphere may be derived from natural sources, such as respiration, or from human activities, including the combustion of fossil fuels. The environmental effects of CO₂ in the atmosphere are of particular concern because CO₂ is a “greenhouse gas”. A greenhouse gas can absorb light and radiate heat instead of reflecting it, elevating the temperature of the gas, thus contributing to global warming. To prevent the production of carbon dioxide, flaring is minimized whenever possible in industrial production processes, but is common in startup and shutdown processes due to pressure changes.

Accordingly, there exists a need for a procedure to shutdown a gas treatment plant while simultaneously minimizing flaring.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for shutting down a gas treatment plant with flare minimization by operating a gas treatment plant as a batch process after cutting feed gas during the shutdown to allow for further processing pressure equalization with downstream headers is reached. The method includes reducing a sour gas feed flow rate from a production flow rate to a shutdown flow rate and subsequently increasing an overhead temperature to a temperature setpoint for an acid gas removal stripper. Once a valve is closed in the sour gas feed, one or more header pressures and one or more overhead pressures are monitored simultaneously, and one or more valves are closed when these pressures equalize. The method includes maintaining a valve in a dry sweet gas line to a flare gas recovery unit in a partially opened position from the Triethylene Glycol contactor, a valve in a wet sweet gas line to the flare gas recovery unit in a partially opened position from the Triethylene Glycol contactor, a valve in an acid gas line to the sulfur recovery unit in an open position, a valve in a flared gas line to a flare gas recovery unit in a partially opened position from the acid gas removal stripper, and a valve in the fuel gas line to the acid gas removal stripper in an open position. The method includes sampling the rich solvent exiting the flash drum to verify a setpoint concentration of hydrogen sulfide has been reached to initiate a final system shutdown.

Other aspects and advantages of the claimed subject matter will be apparent from the following description and the appended claims.

### BRIEF DESCRIPTION OF DRAWINGS

FIG. 1 is a detailed process flow diagram in accordance with one or more embodiments.

FIG. 2 is a process flow chart in accordance with one or more embodiments.

FIG. 3 is a graph of gas flow rate against time in accordance with one or more embodiments.

FIG. 4 is a graph of Acid Gas Removal gas flow rate against time in accordance with one or more embodiments.

FIG. 5 is a graph of sweet gas and sour gas flow against time in accordance with one or more embodiments.

FIG. 6 is a graph of the overhead temperature of the acid gas removal stripper against time in accordance with one or more embodiments.

FIG. 7 is a graph of acid gas and sour gas flow against time in accordance with one or more embodiments.

FIG. 8 is a graph of flare gas recovery unit gas against time in accordance with one or more embodiments.

### DETAILED DESCRIPTION

In one aspect, embodiments disclosed herein relate to a shutdown procedure for a sour gas treatment process producing dry, sweetened gas with minimal flaring.

In conventional sour gas treatment systems, when the sour gas feed is turned off the system, including sweet, flash, enrichment, and acid gas, is depressurized into flare headers, increasing the total plant emissions. During this shutdown process, the system generally continues in a hot circulation state to strip the dissolved gases from methyl diethanolamine (MDEA), including hydrogen sulfide to achieve a concentration of less than 10 ppm while venting to flare headers. The final steps of shutdown are to switch to a cold circulation mode and drain the solvent.

Accordingly, embodiments disclosed herein are related to shutdown procedures which reduce, or eliminate, the amount of gas sent to flare. Such procedures are more efficient and result in less greenhouse gas emissions.

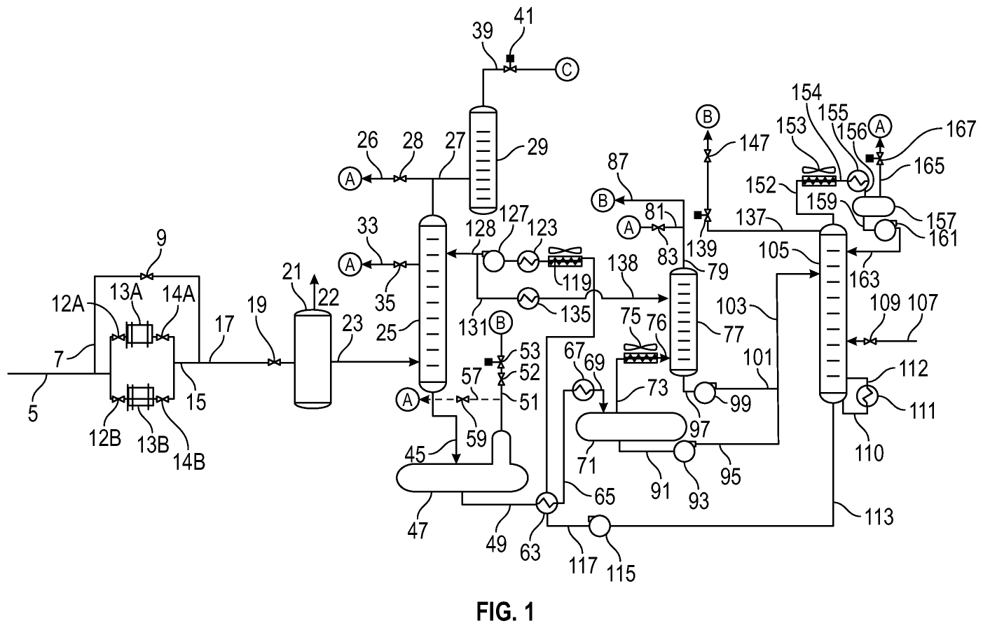

FIG. 1 illustrates the sour gas treatment process according to embodiments disclosed. In FIG. 1, a sour gas line 5 carries sour gas, which has a hydrogen sulfide concentration of 3-5 wt %, to two parallel sour gas heaters 13A, 13B. A sour gas bypass line 7 with a valve 9 is also provided to bypass the heaters during warmer weather conditions. The sour gas line 5 splits into two parallel streams with a valve 12A in the first line and a valve 12B in the second line. In each of the parallel streams, the sour gas exits the valve 12A, 12B and flows into the sour gas heater 13A, 13B, respectively. The sour gas heater 13A, 13B heat the sour gas from an inlet temperature of 47-63° F. to an outlet temperature of 68-92° F. In each of the parallel streams, there is a second valve 14A, 14B at the outlet of each of the sour gas heaters 13A, 13B, respectively. The two parallel streams reconnect to form a heated sour gas line 15 that is intersected by the bypass line 7. The sour gas heaters 13A, 13B may be operated together to increase heater capacity, or alternately to provide heater redundancy during maintenance or unexpected failures.

Following the reconnection of the heated sour gas line 15 and the bypass line 7, the sour gas line 17 flows through a pressure control valve 19 and to a sour gas knockout unit 21. The sour gas knockout unit 21 removes water or entrained liquids from a sour gas stream 22. The dry, sour gas effluent from the sour gas knockout unit 21 flows through a flow line 23 to an Acid Gas Removal (AGR) contactor 25. The AGR contactor 25 receives a sour gas stream 22 and a solvent stream 128. Within the unit, as each stream passes each other, the hydrogen sulfide in the gas stream transfers to the solvent stream, resulting in a wet sweet gas and a hydrogen sulfide containing solvent exiting the AGR contactor 25. The AGR contactor 25 produces a wet sweet gas, containing 0 to 4 ppm hydrogen sulfide, at the top of the AGR contactor 25 that flows to two flow lines. The first flow line 33 contains a valve 35 and flows the wet sweet gas to the Flare Gas Recovery Unit (FGRU) A. The second flow line carrying the wet sweet gas subsequently splits into two flow lines. The first flow line 27 flows to the bottom of a Triethylene Glycol (TEG) contactor 29. The second flow line 26 flows to the Flare Gas Recovery Unit (FGRU) A, containing a valve 28 in the line 26. The FGRU removes hydrogen sulfide and carbon dioxide from flare gas with a maximum capacity of 10.25 MMSCFD, for example. The FGRU is fed flare gas by flare headers, consisting of high pressure, low pressure, and low temperature headers, each equipped with a knockout drum to remove any liquids from the flare gas. Once the flare gas is compressed, it is routed to the fuel gas network. Referring back to the TEG contactor 29, a TEG solution recirculates through the top of the TEG contactor 29. The TEG solution absorbs water during the production of sweet gas and is regenerated for recirculation. Wet sweet gas is gas that has little to no hydrogen sulfide and contains methane, ethane, and butane. Dry gas contains at least 85% methane. The TEG contactor 29 produces a dry sweet gas that flows through a flow line 39 to direct the dry sweet gas towards the master gas system C. The flow line 39 contains a safety valve 41 in the flow line 39. Flow line 39 leads to a header leading to a master gas system. Safety valves in this system are safety isolation valves connected to an Emergency Shutdown System.

The AGR contactor 25 produces solvent containing hydrogen sulfide, in an amount from 62-82 wt %, exiting the AGR contactor 25 through a flow line 45 to a flash drum 47 A flash drum is used for rapid separation of a mixture into a liquid and a vapor by flash evaporation caused by a drop in pressure. The flash drum reduces the pressure of the solvent in flow line 45 to 82-112 psig, producing flash gas through a flow line 51 leading to a header routed towards the Sulfur Recovery Unit (SRU) B with two valves in series in the line. The SRU uses an EUROCLAUS® process to produce sulfur. The process consists of four stages including a thermal stage, a catalytic Claus stage, a catalytic EUROCLAUS® stage, and a catalytic SUPERCLAUS® stage. The four stages are following by a thermal oxidizer burner to combust the remaining gas containing residual hydrogen sulfide and other sulfur compounds that cannot be released directly to the environment. The sulfur removed is consolidated to dedicated sulfur handling facilities. The first valve 52 is a pressure control valve. The second valve 53 is a safety valve. Flow line 57 is provided to route a portion of the flash gas in flow line 51 to FGRU A through a valve 59 in the line 57 branching off from the flow line 51 exiting the flash drum 47. This flow line 57 may or may not be in use during operations. This flow line 57 is in use when the flash gas is not being diverted to the SRU or during a shutdown and depressurization.

The flash drum 47 also produces a solvent through a flow line 49, with the solvent having between 63-83 wt % hydrogen sulfide. The solvent is fed to two heat exchangers in series. The solvent flows through a flow line 49 to the first heat exchanger 63, resulting in an outlet temperature between 230-270° F. The first heat exchanger 63 is heated by a lean solvent stream 117. The effluent of the first heat exchanger 63 flows through a flow line 65 to a second heat exchanger 67, producing a heated solvent, ranging between 211-285° F., in a flow line 69 feeding a second flash drum 71. The second heat exchanger 67 is heated by low pressure steam. The flow line 49 may contain a sample port.

The second flash drum 71 produces two streams: an enrichment gas flowing through a flow line 73 and a solvent flowing through a flow line 91, with the solvent having between 4-5% hydrogen sulfide. The enrichment gas flowing through a flow line 73 is directed to an air cooled heat exchanger 75, resulting in an outlet temperature of 119 to 161° F. An air cooled heat exchanger is heat rejection equipment where the excess process heat from a process gas is rejected to the atmosphere. The cooled enrichment gas exits the air cooled heat exchanger 75 and flows through a flow line 76 to an enrichment contactor 77. The enrichment contactor 77 is also fed from a flow line 138 containing an amine-based solvent. Within the unit, as each stream passes each other, the hydrogen sulfide in the gas stream transfers to the solvent stream, resulting in a gas and a hydrogen sulfide containing solvent exiting the enrichment contactor 77. The enrichment contactor 77 produces an enrichment gas that flows through a flow line 79 that splits off in two potential pathways. In one pathway, a flow line 81 intersects the flow line 79 and directs the enrichment gas to the FGRU A. There is a valve 83 in this flow line 81. In the other pathway, a flow line 87 directs the enrichment gas to the SRU B. Flow line 87 leads to a header leading the SRU B. The enrichment gas follows the pathway to the FGRU A as needed during shutdown or depressurization. The enrichment gas follows the pathway to the SRU B during normal operations.

The enrichment contactor 77 produces a solvent that flows through the flow line 97 to a pump 99 and then through a flow line 101, with the solvent having between 4-5 wt % hydrogen sulfide. The pump 99 raises the pressure in the line to 74-98 psig. This flow line 101 is combined with a flow line 95 containing solvent from the flash drum 71. The flow line 91 feeds the solvent to a pump 93 and through another flow line 95 that is combined with the solvent flow line 101. The pump 93 raises the pressure in the line to 74-98 psig. These flow lines combine to form a flow line 103 that carries solvent to the AGR stripper 105, with the solvent having between 1-3 wt % hydrogen sulfide.

The AGR stripper 105 is fed by the solvent flow line 103 and a fuel gas line 107 containing a valve 109 in the line. The valve 109 in the fuel gas line 107 is closed during normal operations, generally opening during shutdown procedures. In the AGR stripper 105, hydrogen sulfide is removed from the solvent and a hydrogen sulfide gas and a solvent without hydrogen sulfide are produced. The AGR stripper 105 has a flow line 110 out of the bottom of the stripper 105 that feeds solvent through a reboiler 111. The solvent in flow line 112 circulates back to the AGR stripper 105 to provide heat duty to the AGR stripper 105. The lean solvent exits the bottom of the stripper through a flow line 113 that feeds the solvent to a pump 115 and through a flow line 117. The pump 115 raises the pressure in the line to 261-351 psig. The flow line 117 flows through a heat exchanger 63, lowering the temperature to between 165-223° F. and then to an air cooled heat exchanger 119 resulting in an outlet temperature of 119-161° F. The effluent of the air cooled heat exchanger 119 flows to a heat exchanger 123 and to a pump 127. The heated and pressurized solvent is pumped through a flow line that splits in two fractions at a range of 720-975 psig. In one fraction, the flow line 128 flows the solvent to the AGR contactor 25. In the other fraction, the flow line 131 passes through a heat exchanger 135 to feed the enrichment contactor 77 through a flow line 138.

The AGR stripper 105 produces an acid gas that is fed to a flow line 137, containing between 51-69 wt % hydrogen sulfide. The flow line 137 contains a safety valve 139 and a pressure control valve 147. The flow line 137 flows the acid gas to the SRU B.

The AGR stripper 105 also produces an acid gas stream that flows through a flow line 152, having between 51-69 wt % hydrogen sulfide. This gas stream is fed at a range of 119-161° F. to an air cooled heat exchanger 153 and a heat exchanger 155 in series, resulting in an outlet temperature of 94-127° F. The cooled gas flows from the air cooled heat exchanger 153 through a flow line 154 to a reflux drum 157. The reflux drum 157 produces an acid gas that flows through a flow line 165 containing a safety valve 167 and then to a header leading to the FGRU A. The reflux drum 157 also produces a solvent stream that flows through a flow line 159 to a pump 161. The effluent from the pump 161 flows through a flow line 163 back into the AGR stripper 105. The pump 161 raises the pressure in the line to 105-143 psig.

Overall, the shutdown procedure minimizes flaring by shutting off the sour gas feed and continuing to operate the process units as a batch system until pressure equalization is reached between process units and downstream headers. Once pressures are equalized, increasing steam duties and increasing the AGR stripper liquid level reduces the flow of acid gas. Remaining traces of acid gas are mixed in the column with fuel gas to mitigate high hydrogen sulfide impact on the FGRU. A sequential depressurization is carried out at a maximum rate of 10 MMSCFD to meet requirements of the FGRU, which receives and processes the depressurized gases of the flare headers.

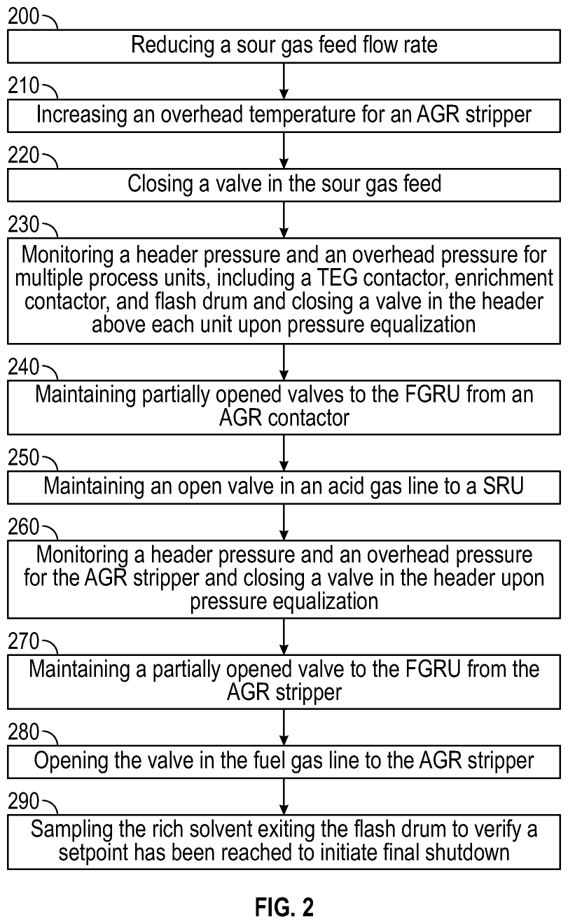

FIG. 2 is a flow diagram of the shutdown procedure for the system illustrated in FIG. 1. In step 200, the sour gas feed flow rate (5, FIG. 1) is reduced from a production flow rate to a shutdown flow rate, which may, for example, reduce the normal operating flow rate by 40-60%. For example, for a plant having a capacity of processing approximately 665 million standard cubic feet per day (MMSCF/d) as the production rate, the sour gas feed flow rate may be reduced to a shutdown flow rate of about 333 MMSCF/d. At this flow rate, the turndown ratio has been reached. The turndown ratio is the range in which a flow meter or controller can accurately measure the fluid. In step 210, the overhead temperature for the acid gas removal stripper (105, FIG. 1) is increased at a rate of 1 to 5° F. per hour until a first temperature setpoint is reached. The first temperature setpoint falls in a range of 250° F. and 300° F. During this increase, the level is monitored in the reflux drum (157, FIG. 1), the rich solvent inlet (137, FIG. 1) is maintained at a second temperature setpoint of 225 to 275° F., and the valve (109, FIG. 1) in the fuel gas line (107, FIG. 1) to the AGR stripper (105, FIG. 1) is manually closed. In step 220, the valve in the sour gas feed (19, FIG. 1) is closed. In step 230, the header pressure and overhead pressure for several process units are monitored simultaneously. Once the header pressure and overhead pressures are equalized, a valve in each header is closed. The header pressure in the header leading to the master gas system C from the TEG contactor (29, FIG. 1) and an overhead pressure for the TEG contactor (29, FIG. 1) are monitored. When these two pressures are equalized, a valve (41, FIG. 1) in the line flowing the dry sweet gas from the TEG contactor (29, FIG. 1) to the master gas system is closed. The header pressure in the header leading to the SRU B from the enrichment contactor (77, FIG. 1) and an overhead pressure for the enrichment contactor (77, FIG. 1) are monitored. When these two pressures are equalized, a valve (86, FIG. 1) in the line flowing the enrichment gas from the enrichment contactor (77, FIG. 1) to the SRU B is closed. The header pressure in the header leading to the SRU B from the flash drum (47, FIG. 1) and an overhead pressure for the flash drum (47, FIG. 1) are monitored. When these two pressures are equalized, a safety valve (53, FIG. 1) in the line flowing from the flash drum (47, FIG. 1) to the SRU B is closed.

In step 240, the pressure control valve (35, FIG. 1) in a wet sweet gas line to the FGRU A (33, FIG. 1) from the AGR contactor (25, FIG. 1) is adjusted to partially opened positions, between 1% and 10%.

In step 250, the valve (167, FIG. 1) in the acid gas line to the SRU (B, FIG. 1) is opened. When this valve (167, FIG. 1) is opened, the valve in the fuel gas line (109, FIG. 1) is closed, the overhead temperature of the AGR stripper (105, FIG. 1) is maintained between 250° F. to 300° F., and the rich solvent inlet (137, FIG. 1) is maintained at a range of 187° F. to 253° F.]. In step 260, the header pressure in the header leading to the SRU B from the AGR stripper (105, FIG. 1) and an overhead pressure for the AGR stripper (105, FIG. 1) are monitored. When these pressures equalize, the AGR stripper level is increased to a level setpoint with a range between 70% to 90%. Once the level is reached, the safety valve (167, FIG. 1) is closed. In step 270, the pressure control valve (145, FIG. 1) in the flared gas line from the AGR stripper (105, FIG. 1) to the FGRU A is adjusted to a partially opened position, between 1% and 10%. In step 280, the valve (109, FIG. 1) in the fuel gas line (107, FIG. 1) to the AGR stripper (105, FIG. 1) is manually opened. In step 290, a sample port in the flow line containing rich solvent (49, FIG. 1) is utilized to verify a setpoint concentration of hydrogen sulfide in the solvent has been reached to initiate final shutdown procedures. The setpoint concentration is below 10 ppm. OIM 9530 is followed for cold circulation and solvent drainage.

### Example

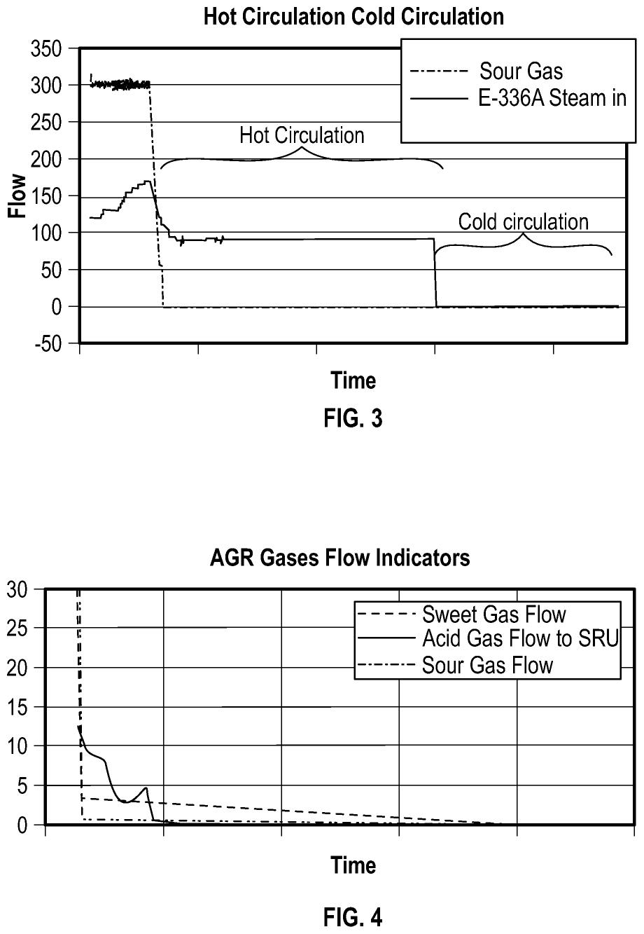

Testing was conducted while monitoring process parameters and conducting laboratory sampling. FIGS. 3-7 demonstrate results of the testing that indicate effective shutdown with minimal flaring.

FIG. 3 is a graph of the flow rate against time during hot and cold circulation. FIG. 3 shows the fluctuations in flow rate over time of the sour gas and the steam from the reboiler (111, FIG. 1). FIG. 3 demonstrates that as the sour gas feed is cut off, the system goes into hot circulation for a first period of time, such as between 36 and 72 hours, followed by a state of cold circulation. This graph illustrates the sour gas feed rate between hot and cold circulation modes. The hot circulation mode is achieved by closing the valve (19, FIG. 1) in the sour gas feed (17, FIG. 1). The cold circulation mode is achieved by closing a valve in the steam line to the reboiler (111, FIG. 1) once the hydrogen sulfide in the solvent is reduced to less than 10 ppm.

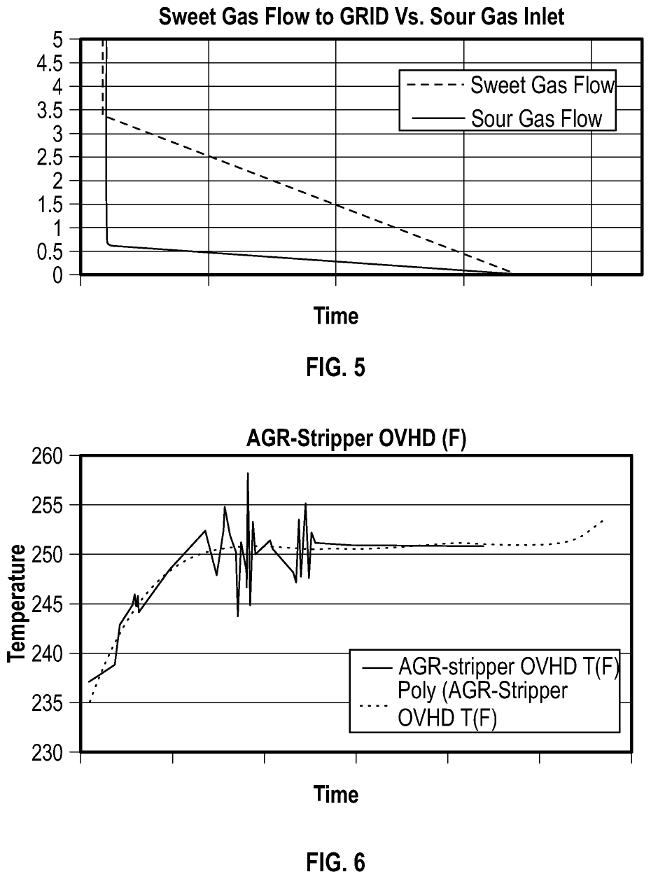

FIGS. 4 and 5 are graphs of AGR gases and the system response to shutting off the sour gas feed. FIG. 4 shows the acid gas flow rate lowering to zero over time after the sour gas is shut off and the sweet gas flow rate linearly decreasing to zero over time, demonstrating the impact of stopping the sour gas feed on the progression of the shutdown, including continued production of sweet gas for a period of time following sour gas feed shut off. FIG. 5 shows the sweet gas flow rate lowering to zero over time after the sour gas is shut off. The sweet gas continues to produce an additional 33.8 MMSCF after exceeding the turndown rate and the closure of the sour gas feed and then gradually reduces to 0 MMSCF.

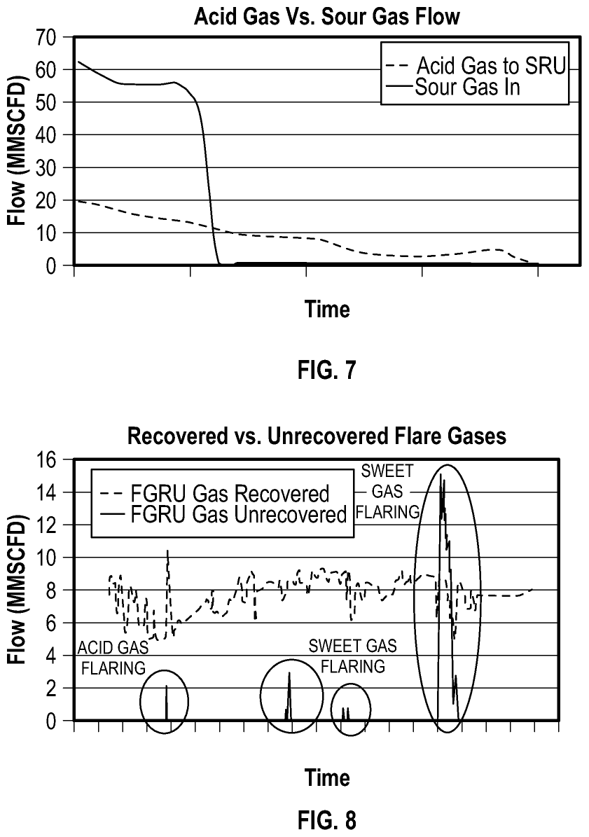

FIG. 6 is a graph showing the incremental increase in temperature in the AGR stripper of 1 to 5° F. per hour until a first temperature setpoint is reached of 252° F. FIG. 7 shows the flow rate of the sour gas and acid gas over time.

Lab sampling indicated that the system was able to obtain a concentration in the solvent of 7 PPM within two days while supplying 24 MMSCF of acid gas to the SRU and FGRU rather than going to flaring operations.

FIG. 8 is a graph showing the flow of FGRU gas recovered and unrecovered against time. The recovered line represents the gas recovered from the flare gas recovery unit that can be recycled to the process of captured for export. The unrecovered line is the amount that is flared. FIG. 8 shows that there is a significant amount of recovered gas relative to unrecovered gas.

The testing indicated that, using the modified shutdown procedure compared to conventional shutdown procedures, flaring was successfully minimized by 93%, SO2 emissions were reduced by 99%, and additional sweet and acid gas production occurred after the sour gas feed was shut off.

Embodiments of the present disclosure may provide at least one of the following advantages. The modified shutdown process minimizes the need for gas flaring to relieve pressure, thus reducing unnecessary carbon dioxide production. The modified shutdown procedure allows for continued production following the initiation of the shutdown procedure when cutting off the sour gas feed, resulting in additional final product yield. The procedure results in less SO2 emissions than a conventional shutdown procedure.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method for shutting down a gas treatment plant with flare minimization, comprising:
reducing a sour gas feed flow rate from a production flow rate to a shutdown flow rate;
increasing an overhead temperature to a first temperature setpoint for an acid gas removal stripper;
closing a valve in the sour gas feed;
monitoring one or more header pressures and one or more overhead pressures and closing one or more valves when the one or more header pressures and the one or more overhead pressures are equalized;
maintaining a valve in a wet sweet gas line to the flare gas recovery unit in a partially opened position from an acid gas removal contactor;
maintaining a valve in an acid gas line to the sulfur recovery unit in an open position;
maintaining a valve on a flared gas line to a flare gas recovery unit in a partially opened position from the acid gas removal stripper;
opening a valve in a fuel gas line to the acid gas removal stripper; and
sampling the rich solvent exiting the flash drum to verify a setpoint concentration of hydrogen sulfide has been reached to initiate a final system shutdown.

2. The method of claim 1, wherein the shutdown flow rate is 40-60% of the production flow rate.

3. The method of claim 1, wherein the first temperature setpoint is between 250° F. and 300° F.

4. The method of claim 1, wherein after maintaining the valve in an acid gas line to the sulfur recovery unit in the open position, the method further comprises:
closing the valve in the fuel gas line to the acid gas removal stripper;
monitoring a level in a reflux drum; and
flowing a rich solvent feed to the acid gas removal stripper until a second temperature setpoint is reached.

5. The method of claim 4, wherein the second temperature setpoint is between 225° F. and 275° F.

6. The method of claim 1, further comprising increasing the overhead temperature at a rate of 1° F. to 5° F. per hour.

7. The method of claim 1, wherein the monitoring comprises:
simultaneously monitoring a header pressure in a header leading to a master gas system from a Triethylene glycol contactor and an overhead pressure for the Triethylene glycol contactor, further comprising closing a valve in a line flowing a dry sweet gas from the Triethylene glycol contactor to the master gas system when the header pressure in the header leading to the master gas system from the Triethylene glycol contactor and the overhead pressure for the Triethylene glycol contactor are equalized;
simultaneously monitoring a header pressure in a header leading to a sulfur recovery unit from an enrichment contactor and an overhead pressure for the enrichment contactor, further comprising closing a valve in a line flowing an enrichment gas from the enrichment contactor to the sulfur recovery unit when the header pressure in the header leading to the sulfur recovery unit from the enrichment contactor and the overhead pressure for the enrichment contactor are equalized;
simultaneously monitoring a header pressure in a header leading to the sulfur recovery unit from a flash drum and an overhead pressure for the flash drum, further comprising closing a valve in a flash gas line from the flash drum to the sulfur recovery unit when the header pressure in the header leading to the sulfur recovery unit from the flash drum and the overhead pressure for the flash drum are equalized; and
simultaneously monitoring a header pressure in a header leading to the sulfur recovery unit from the acid gas removal stripper and an overhead pressure for acid gas removal stripper, further comprising increasing a level in the acid gas removal stripper to a level setpoint and closing the valve in the acid gas line to the sulfur recovery unit.

8. The method of claim 1, wherein the partially open valve on the line to the flare gas recovery unit from the acid gas removal contactor is set between 1% and 10%.

9. The method of claim 1, wherein the partially open valve on the line to the flare gas recovery unit from the acid gas removal stripper is set between 1% and 10%.

10. The method of claim 1, wherein maintaining the valve in the acid gas line to the sulfur recovery unit in an open position further comprises:
maintaining the valve in the fuel gas line in a closed position;
maintaining the overhead temperature for the acid gas removal stripper at the first temperature setpoint; and
flowing the rich solvent feed to the acid gas removal stripper until the second temperature setpoint is reached.

11. The method of claim 1, further comprising increasing the level setpoint in the acid gas removal stripper to the level setpoint of 70% to 90%.

12. The method of claim 1, wherein the setpoint concentration is below 10 ppm.
